(19) United States
(12) Patent Application Publication
(10) Pub. No.: US 2007/0145691 A1
(43) Pub. Date: Jun. 28, 2007

(54) Fluid gasket

(75) Inventor: Masayoshi Katsura, Sanda-shi (JP)

Correspondence Address: KODA & ANDROLIA, 2029 CENTURY PARK EAST, SUITE 1140, LOS ANGELES, CA, 90067, US

(73) Assignee: Nippon Pillar Packing Co., Ltd.

(21) Appl. No.: 11/603,983

(22) Filed: Nov. 22, 2006

(30) Foreign Application Priority Data
Nov. 29, 2005 (JP) 2005-344406

(51) Int. Cl. F16L 17/06

(52) U.S. Cl. 277/609

(57) ABSTRACT

In order to seal-connect a first fluid supply/discharge port portion 1A of a first fluid device 1 having a pipe-like fluid passage 3 and an annular fluid passage 4 with a second fluid supply/discharge port portion 2A of a second fluid device 2 having a pipe-like fluid passage 7 and an annular fluid passage 8, while the passages 3, 4, 7, 8 are mutually correspond to one another, a fluid gasket has first and second ring-like gasket portions G1, G2. In the gasket portions G1, G2, first sealing portions g12, g22 which abut against the first fluid supply/discharge port portion 1A, second sealing portions g11, g21 which abut against the second fluid supply/discharge port portion 2A, and fluid paths w1, w2 through which the passages 3, 4 and the passages 7, 8 communicate with each other. A bridge portion B is placed so as to traverse the fluid path w2, thereby connecting and integrating the first and second ring-like gasket portions G1, G2 with each other.

### BACKGROUND OF THE INVENTION

1. Field of the Invention

The present invention relates to a fluid gasket which is mainly used in a portion connecting fluid devices with each other, and more particularly to a fluid gasket which is interposed for, in a sealed state, communicatingly connecting fluid devices such as an integration panel, a pump, a valve, an accumulator, and a filter in a piping system or the like for high-purity liquid, ultrapure water, cleaning liquid, or the like that is handled in a production process in various technical fields such as semiconductor production, medical and pharmaceutical production, food processing, and chemical industry.

2. Explanation of Related Art

As a conventional fluid gasket, for example, there is a gasket which is employed in a structure portion where a valve which is an example of a fluid device is connected and coupled to an integration panel in which a fluid passage is formed, by causing a pair of supply/discharge flow paths to communicate with each other. Gaskets for a connecting structure are disclosed in Japanese Patent Application Laying-Open Nos. 2001-82609 and 10-169859.

The fluid gasket disclosed in Japanese Patent Application Laying-Open No. 2001-82609 is to be interposed between a pair of supply and discharge flow paths which are juxtaposed each other, and which are liquid-tightly connected and coupled to each other by plural bolts, and consists of plural gaskets which are independently formed. The fluid gasket disclosed in Japanese Patent Application Laying-Open No. 10-169859 is to be interposed between a pair of supply and discharge flow paths which are juxtaposed each other, and which are connected and coupled to each other by a single external screw nut, and configured as a single gasket having a pair of flow path holes.

Both of the fluid gaskets disclosed in Japanese Patent Application Laying-Open Nos. 2001-82609 and 10-169859 are used in a connecting structure employing a structure in which many fluid apparatuses are integrately attached to a fluid block, or a so-called integrated piping structure. These gaskets are useful for compactifying or modularizing the whole of a piping system. In order to further compactify or modularize a system, it is a matter of course that each fluid device must be miniaturized, and it is anticipated that, after compactification of each fluid device is realized, a gasket which can contribute to compactification of a connecting structure for fluid devices such as an integration panel and a fluid device becomes necessary.

### SUMMARY OF THE INVENTION

It is an object of the invention to realize and provide a fluid gasket which can further compactify a connecting structure for fluid devices, and which, for example, can contribute to promotion of integration of a piping system using an integration panel having the above-described advantage.

The invention provides a fluid gasket having:

plural ring-like gasket portions which, in order to communicatingly connect a first fluid supply/discharge port portion of a first fluid device having the first fluid supply/discharge port portion where a pipe-like or annular fluid passage, and one or more annular fluid passages are concentrically formed and opened, to a second fluid supply/discharge port portion of a second fluid device having the second fluid supply/discharge port portion where a pipe-like or annular fluid passage, and one or more annular fluid passages are concentrically formed and opened, in a state where respective ones of the plural fluid passages correspond to each other and are sealed, are to be interposed between the first fluid supply/discharge port portion and the second fluid supply/discharge port portion, and in which first sealing portions that are to abut against the first fluid supply/discharge port to perform a sealing operation, second sealing portions that are to abut against the second fluid supply/discharge port to perform a sealing operation, and a fluid path for communicating the fluid passages of the first fluid supply/discharge port portion with the fluid passages of the second fluid supply/discharge port portion are formed; and

a bridge portion which is placed in a state where the bridge portion traverses the fluid path in order to couple and integrate ones of the plural ring-like gasket portions with each other, the ones being adjacent to each other in a radial direction.

According to the invention, the first sealing portion which is one end portion of each of the ring-like gasket portions, and the second sealing portion which is the other end portion abut the fluid supply/discharge ports, respectively, thereby performing sealing operations, and therefore the fluid devices are communicatingly connected to each other in a sealed state. When two or more fluid passages are formed as concentric multiplex pipes as described above, it is possible to obtain a fluid gasket which is useful for compactifying a connecting structure portion as compared with a structure in which plural fluid passages are independently arranged. When this connecting structure is used in a piping system for a cleaning apparatus in a semiconductor device producing facility, for example, the occupation area of the apparatus can be reduced while ensuring a sealing property, and hence the structure is advantageous from the viewpoint of cost. Furthermore, a large fluid path can be ensured, and hence the circulating flow amount can be increased, and the purities of chemicals can be made higher, thereby attaining an effect that the invention can contribute to improvement of the yield.

Among the plural inner and outer ring-like gasket portions, portions which are adjacent to each other in a radial direction are connected and integrated with each other by the bridge portion which is placed in a state where the bridge portion traverses the fluid path, and the gasket is configured as a single component. As compared with means in which ring-like gasket portions are independent and plural gaskets are used, the trouble and time required for assembly can be reduced. Furthermore, the number of components is reduced, and hence the possibility that gaskets are lost can be correspondingly lowered. In an assembled state, since such a gasket is pressingly inserted into a fluid supply/discharge port portion or the gasket is closely fitted, the work of detaching the gasket tends to be hardly conducted. According to the fluid gasket of the invention, for example, the bridge portion can be nipped and pulled, and therefore the work of detaching the gasket can be easily conducted by using the existence of the bridge portion.

As a result, a fluid gasket which can contribute to promotion of integration of a piping system using an integration panel having various advantages, and which therefore enables further compactification of a connecting structure for fluid devices is configured as a single component in which the plural ring-like gasket portions are integrated by the bridge portion, and can be provided as a preferred component by which the attaching and detaching works can be simplified and efficiently conducted.

The invention is characterized in that, in the fluid gasket set forth in claim 1, the bridge portion is set to have a section in which a dimension of the fluid path along an axial direction is larger than a dimension along a radial direction with respect to the axis.

According to the invention, the bridge portion which traverses the fluid path can have a section shape which hardly constitutes a resistance (hindrance) to the flow of the fluid. Therefore, the above-mentioned effects of the invention of claim 1 can be attained in a state where the bridge portion hardly adversely affects the flow of the fluid.

The invention is characterized in that, in the fluid gasket set forth in claim 1, the bridge portion is formed into a screw-like shape which can change a flow direction of a fluid in the fluid path.

According to the invention, a function of, when the fluid passes the bridge portion formed into a screw-like shape, changing or twisting the flow direction of the fluid is produced. When the pipe in the downstream side is largely bent, or the inner wall of the pipe is corrugated, for example, an action of stirring the fluid is caused in the bent portion or the recess portion, thereby eliminating the phenomenon that the fluid stagnates in the portion. Therefore, it is possible to provide a fluid gasket in which an effect that a satisfactory flow state is obtained can be expected.

The invention is characterized in that, in the fluid gasket set forth in claim 1, the bridge portion is formed into a spiral shape to enable swirl motion to be applied to a flow of a fluid in the fluid path.

According to the invention, when a fluid such as water flows in the pipe while swirling, the bridge portion is formed into a shape which extends along the flow, and the resistance to the flow can be reduced.

The invention is characterized in that, in the fluid gasket set forth in the first invention, the plural ring-like gasket portions comprise: the first sealing portion having a first annular groove which is to be fitted to a first annular projection formed on an outer-diameter portion of the fluid passage of the first fluid supply/discharge port portion, thereby allowing the first sealing portion to be formable; and the second sealing portion having a second annular groove which is to be fitted to a second annular projection formed on an outer-diameter portion of the fluid passage of the second fluid supply/discharge port portion, thereby allowing the second sealing portion to be formable, the fittings being performed so that, in a joined state where the first fluid supply/discharge port portion and the second fluid supply/discharge port portion are attracted to each other, the first annular projection is fitted to the first annular groove, and the second annular projection is fitted to the second annular groove, the gasket presents a substantially H-like section shape to freely form fitting sealing portions in which the first annular projection and the first annular groove, and the second annular projection and the second annular groove are pressingly contacted with each other in a radial direction.

According to the invention, the annular projections respectively formed in the first and second fluid supply/discharge port portions are fitted into the annular grooves respectively formed in the first and second sealing portions of the ring-like gasket portions, to form the fitting sealing portions. Therefore, liquid leakage from between the first and second fluid supply/discharge port portions can be blocked, and it is possible to obtain an excellent sealing property. The holding means can hold the joined state where the fluid supply/discharge port portions are attracted to each other and sealed by the ring-like gasket portions. Therefore, it is possible to provide a fluid gasket by which the state where liquid leakage does not occur in both the fluid devices and the excellent sealing property can be ensured can be held for a long term, and the connecting structure for fluid devices can be provided with high reliability.

In a fitting structure in which a convex is inserted into a concave, it is generally known that, even when the convex and the concave are made of the same material, the convex-side member is hardly changed (compressively deformed), and the concave-side member tends to be expandingly deformed. In the fifth invention, therefore, the annular projections which are convex are formed on the fluid devices, and the annular grooves which are concave are formed in the fluid gasket. Accordingly, a component which may be deformed because of occurrence of creep or aging is on the side of the fluid gasket which is smaller than the fluid devices, and the fluid devices are hardly deformed. Consequently, there is an effect that the advantage that an excellent sealing property can be held for a long term by replacing the fluid gasket can be economically realized.

Moreover, in a configuration where fluid passages are formed outside and inside of the fluid gasket, not only the inner peripheral portion of an intermediate ring-like gasket portion, but also the outer peripheral portion thereof functions as a wall of a fluid path. Therefore, inner and outer fluid passages which are adjacent to each other are separated only by the thickness of the intermediate ring-like gasket portion, and plural fluid passages can be placed closely in a radial direction as far as possible. Accordingly, there is an advantage that a connecting structure for fluid devices can be further compactified. As a result, a fluid gasket which is suitable for a connecting structure for fluid devices in which plural fluid passages are concentrically arranged can be realized. The invention can contribute to promotion of integration of fluid devices which can be advantageously modularized or compactified, and moreover attain effects that an excellent sealing property can be held for a long term, that the reliability is high, and that a connecting structure for fluid devices can be further compactified.

The invention is characterized in that, in the fluid gasket set forth in the fifth invention, in the bridge portion, a thickness along a direction of an axis of the flow path is set to a value which is equal to or lees than a thickness of a connecting portion along the direction of the axis of the flow path, the connecting portion being interposed between groove bottoms of the first and second annular grooves in the ring-like gasket portions, and the bridge portion is formed at a position corresponding to the connecting portion in the axial direction of the flow path.

According to the invention, it is configured so as not to impede the radial displacements of the annular projections which are based on the connecting portion in the ring-like gasket portions, whereby the excellent sealing property is maintained irrespective of the existence of the bridge portion. This is because of the following reason. If the thickness of the bridge portion is larger than the thickness of the connecting portion, a state similar to that where the outer annular projection of the inner-diameter ring-like gasket portion is rigidly connected to the inner annular projection of the outer-diameter ring-like gasket portion is produced, and only the vicinity of the bridge portion is hardly moved in a radial direction, thereby causing the possibility that the sealing property is adversely affected.

The invention is characterized in that, in the fluid gasket set forth in the fifth invention, the fluid gasket has expansion restricting portions formed in end portions of inner and outer peripheral walls which are projected in the axial direction of the fluid path in each of the first and second sealing portions to form the annular grooves, the expansion restricting portions cooperating with support portions which are formed on inner- and outer-diameter portions of the annular projections in end portions of the first and second fluid supply/discharge port portions, to suppress or block expanding deformations of end portions of the inner and outer peripheral walls due to fittings of the annular grooves and the annular projections.

According to the invention, there are the following effects. As described above, in concavo-convex fitting, the concave side tends to be expandingly deformed. It means that, in the invention, the inner and outer peripheral wall end portions which are formed in the fluid gasket in order to form the annular grooves are expandingly deformed. Since the expansion restricting portions which suppress or block expanding deformations of the peripheral wall end portions are disposed in the ring-like gasket portions, expanding deformations of the peripheral wall end portions are eliminated or reduced, and the annular projections and the annular grooves can be fitted together by a strong press contact force. The excellent sealing function due to the fitting between them can be exerted as desired. When the rigidities of the peripheral wall end portions are insufficient, the expansion restricting portions can compensate for the insufficiency. Therefore, the thicknesses of the peripheral wall end portions of the fluid gasket can be reduced as compared with the case where the expansion restricting portions are not disposed. The width of the fluid gasket can be reduced, whereby the whole diameter of plural passages which are concentrically arranged can be compactified, or namely the connecting structure for fluid devices can be further compactified.

The invention is characterized in that, in the fluid gasket set forth in claim 7, the expansion restricting portions are configured so as to be pressingly contacted with the support portions in the joined state to form the sealing portions.

According to the invention, in a joined state of fluid devices, the sealing portions due to the press contacts between the annular projections of the first and second fluid supply/discharge port portions, and the annular grooves of the first or second sealing portion of the ring-like gasket portions are formed. Therefore, it is possible to provide a fluid gasket in which fitting sealing portions having an excellent sealing property are configured, and a connecting structure having a high sealing property between fluid devices is realized.

The invention is characterized in that, in the fluid gasket set forth in the eighth invention, the expansion restricting portions are configured by peripheral wall end portions of the inner and outer peripheral walls which have a forward-narrowed section shape, and which are enterable into valley portions surrounded by the support portions and the annular projections so as to have an inward-narrowed section shape, and, in the joined state, tapered peripheral faces formed on the peripheral wall end portions are pressingly contacted with tapered peripheral faces on a side of the annular projections in the support portions.

According to the invention, in a joined state, a configuration where the tapered peripheral faces of the first and second fluid supply/discharge port portions are pressingly contacted with those of the ring-like gasket portions exists on the inner and outer diameter sides of the fitting portions between the annular projections of the first and second fluid supply/discharge port portions and the annular grooves of the first or second sealing portion of the ring-like gasket portions. Because of the abutting contacts of the tapered peripheral faces, it is possible to attain the both effects of compactification of the connecting structure portion and improvement of the sealing property. Since the structure in which the tapered peripheral faces abut against each other is employed, the press contact force is more increased as the fluid devices are further pressed against the ring-like gasket portions, thereby producing an advantage that the effects of compactification and improvement of the sealing property can be further enhanced. Accordingly, it is possible to provide a fluid gasket having a connecting structure where liquid stagnation does not occur between the tapered peripheral faces.

The invention is characterized in that, in the fluid gasket set forth in the fifth invention, the plural ring-like gasket portions are set so that the substantially H-like section shape is axisymmetric about both a center line along the axis direction of the fluid path, and a center line perpendicular to the center line.

According to the invention, the ring-like gasket portions are vertically and laterally axisymmetric, and the section is formed into a substantially H-like shape. Therefore, the production of the fluid gasket can be simplified as compared with the case of an asymmetric shape. Furthermore, a fluid gasket which is excellent in balance (strength balance, assembling balance) when fitted to fluid devices can be produced.

The invention is characterized in that, in the fluid gasket set forth in the first invention, the fluid gasket is formed by a fluororesin.

According to the invention, the fluid gasket is formed by a fluororesin which is excellent in chemical resistance and heat resistance. Even when the fluid is medical solution or, chemical liquid, or high in temperature, therefore, a situation where the connecting structure portion is deformed and the fluid easily leaks does not occur, and the excellent sealing property can be maintained. A fluororesin is a resinoid material obtained by polymerization of ethylene and its derivative in which one or more hydrogen atoms are substituted with fluorine atoms, and is stable at a high temperature and excellent in water repellency. Furthermore, a fluororesin is preferable in low co-efficient of friction, high chemical resistance, and high electrical insulating property.

### BRIEF DESCRIPTION OF THE DRAWINGS

FIG. 1 is a section view showing a concentric multiplex flow path connecting structure for an integration panel and a valve;

FIG. 2 is a section view of main portions of a fluid gasket which is used in the connecting structure of FIG. 1, and fluid supply/discharge port;

FIG. 3 is an enlarged section view of main portions showing the detail of the connecting structure relating to a ring-like gasket;

FIG. 4 is a plan view of a fluid gasket of Embodiment 1;

FIG. 5 is a section view taken along the line A-A of FIG. 4.

FIG. 6A is a section view of a bridge portion (taken along the line D-D) of FIG. 4, and FIGS. 6B and 6C are section views of main portions showing other section shapes of a bridge portion;

FIG. 7 is a section view showing another concentric multiplex flow path connecting structure for fluid devices;

FIG. 8 is a section view of main portions showing a first other structure of holding means with an attracting function;

FIG. 9 is a diagram showing the connection procedure of a connecting structure having the holding means of FIG. 8;

FIG. 10 is a plan view showing a spiral fluid gasket of Embodiment 2; and

FIG. 11 is a section view of a bridge portion (taken along the line E-E) of FIG. 10.

### DESCRIPTION OF THE PREFERRED EMBODIMENTS

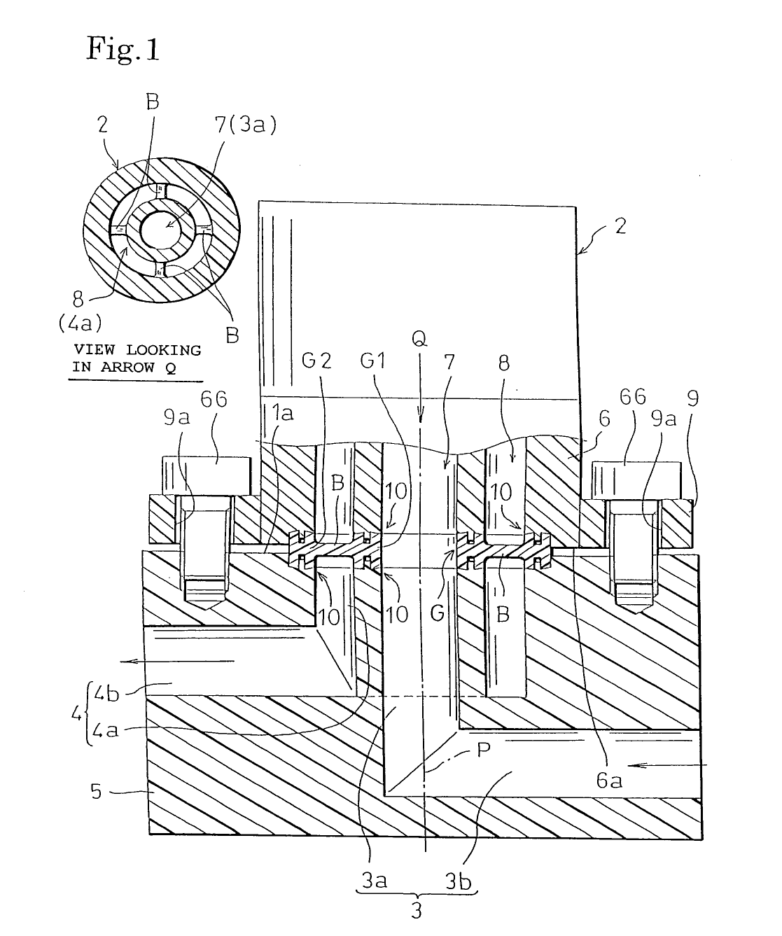

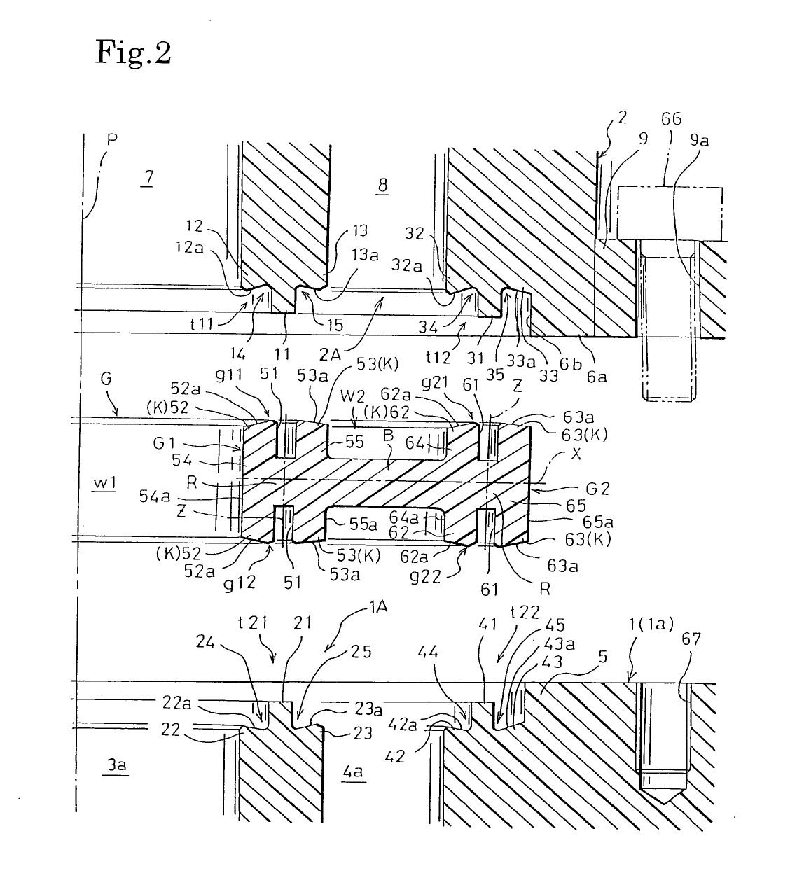

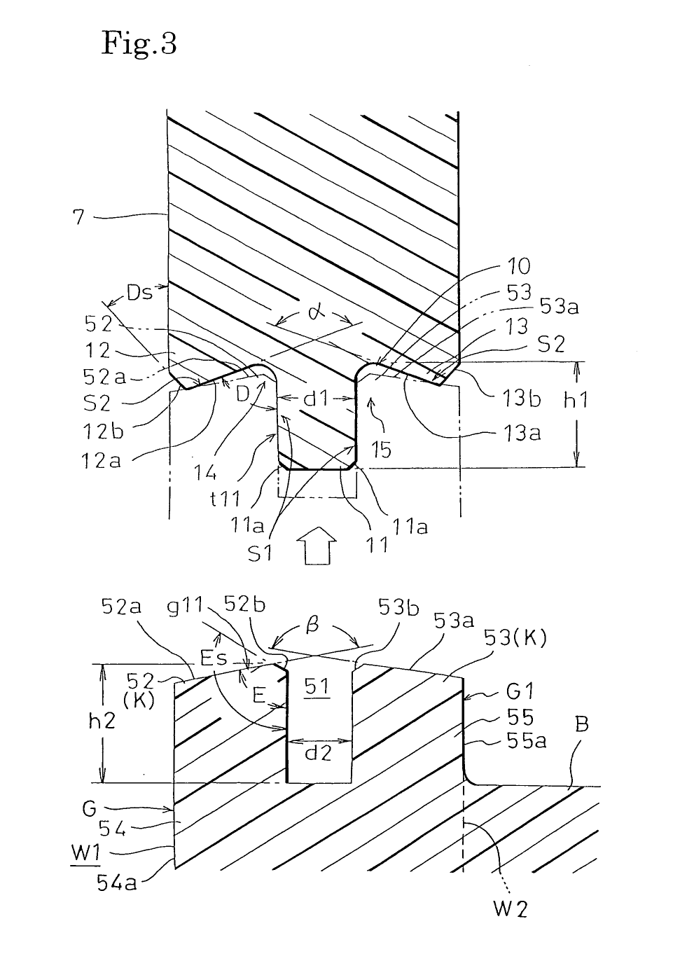

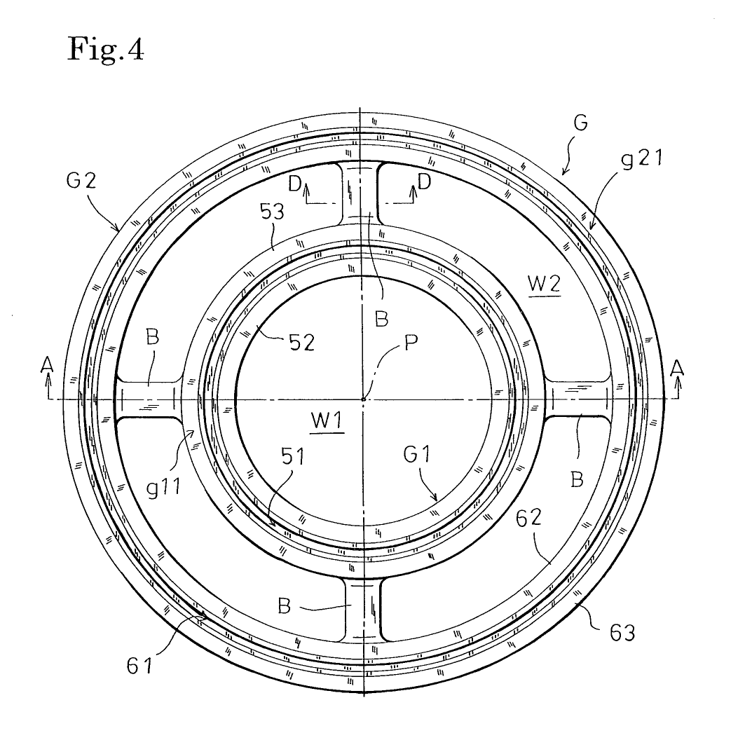

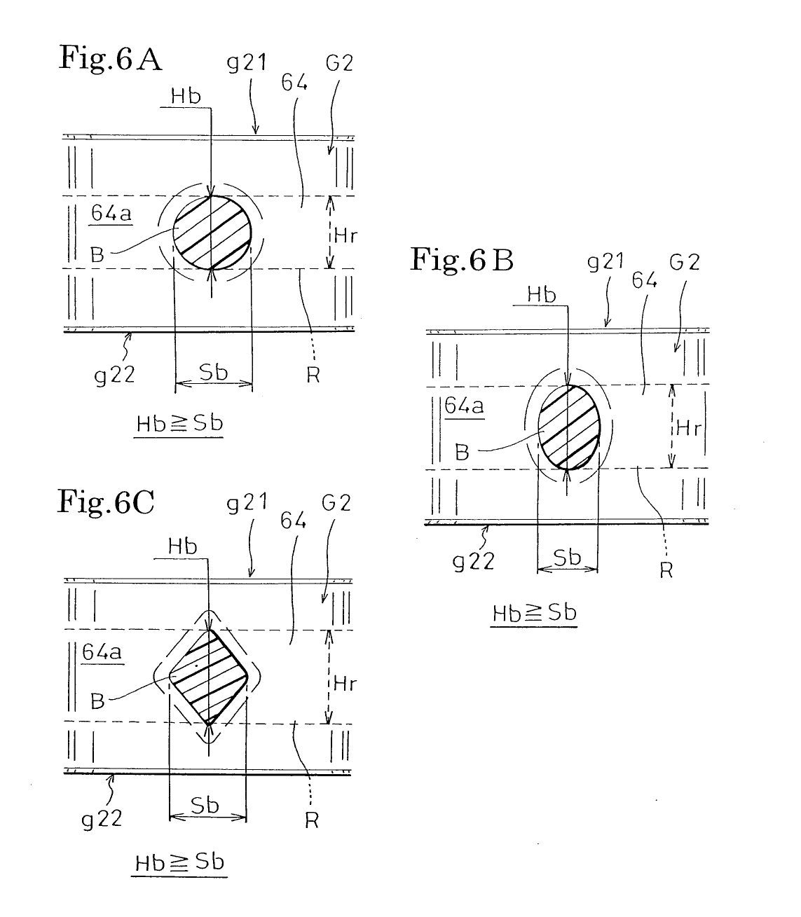

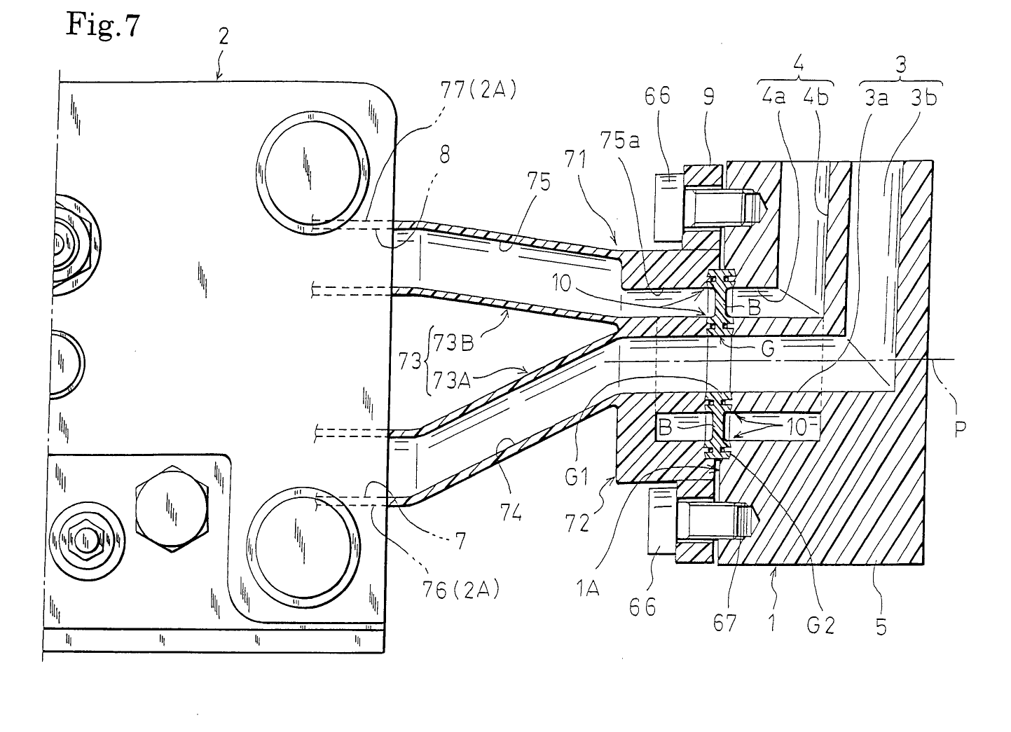

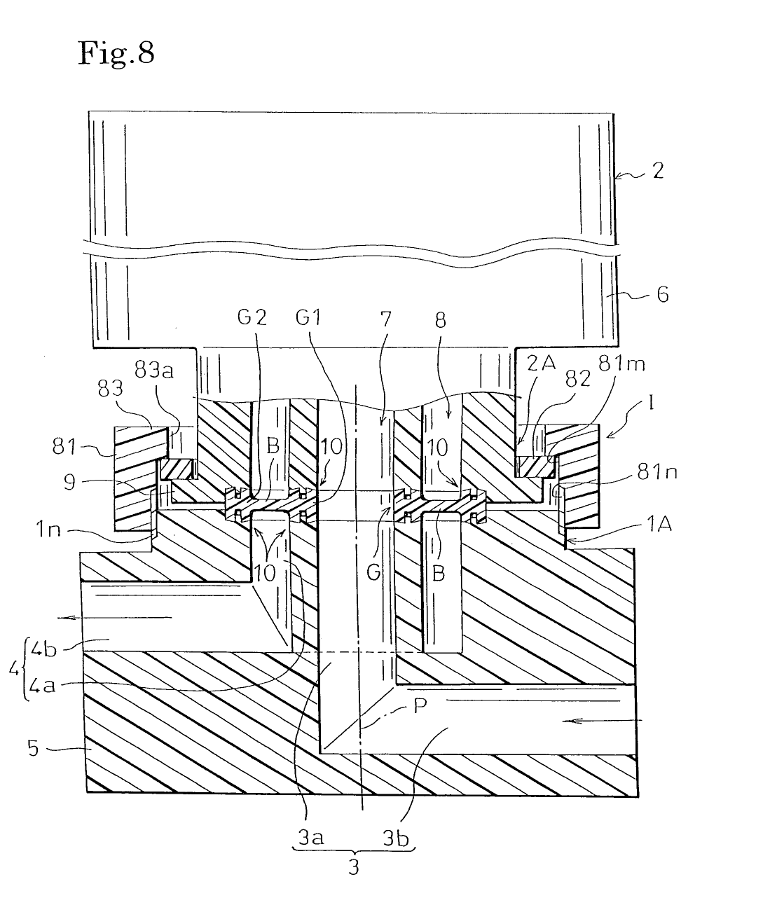

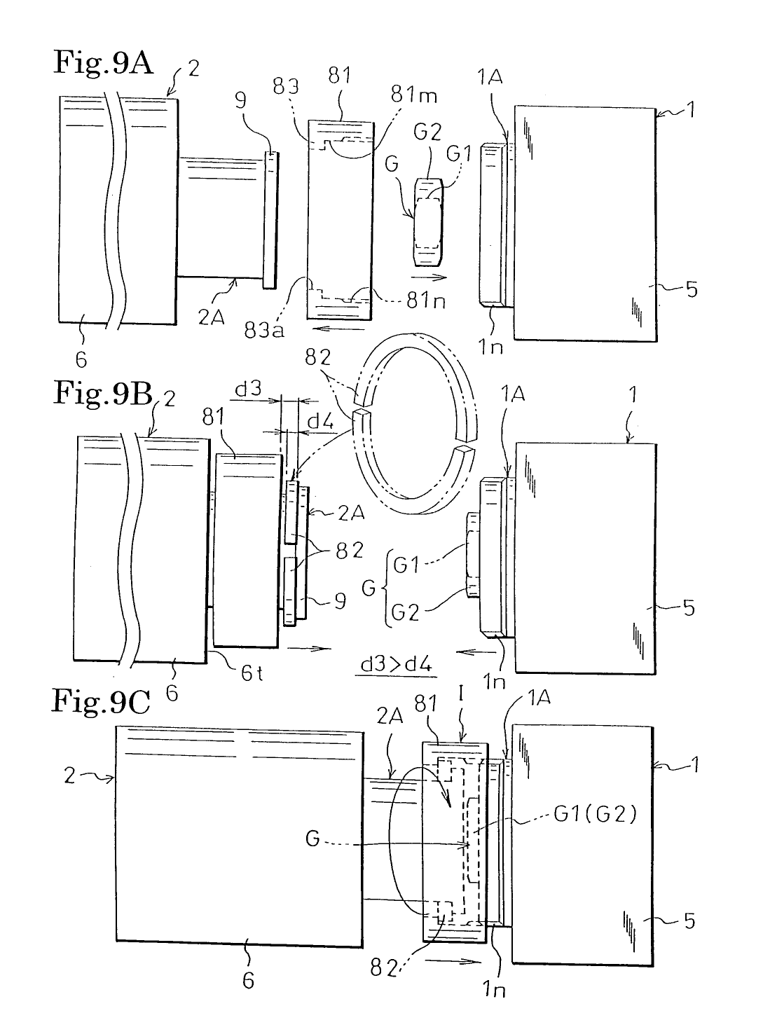

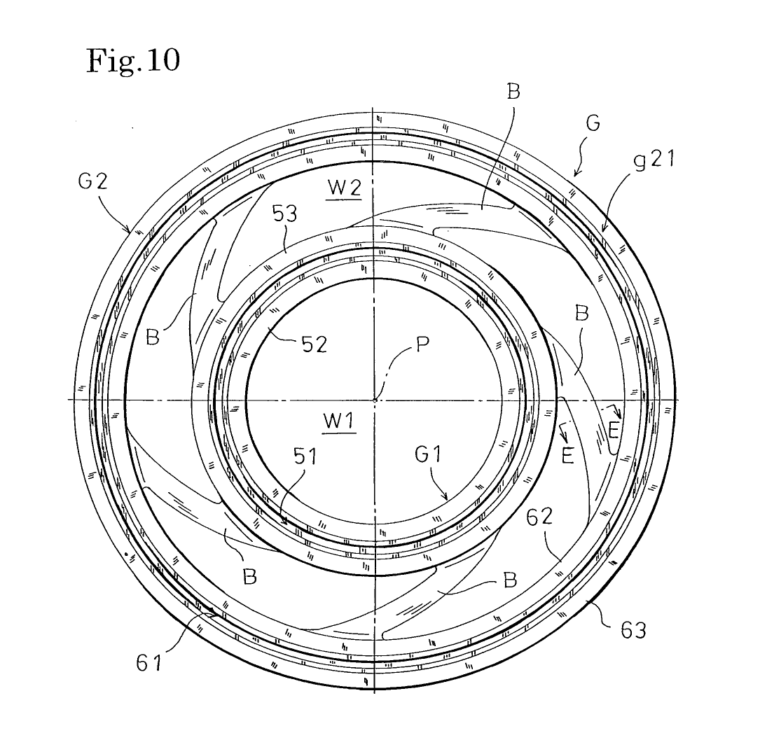

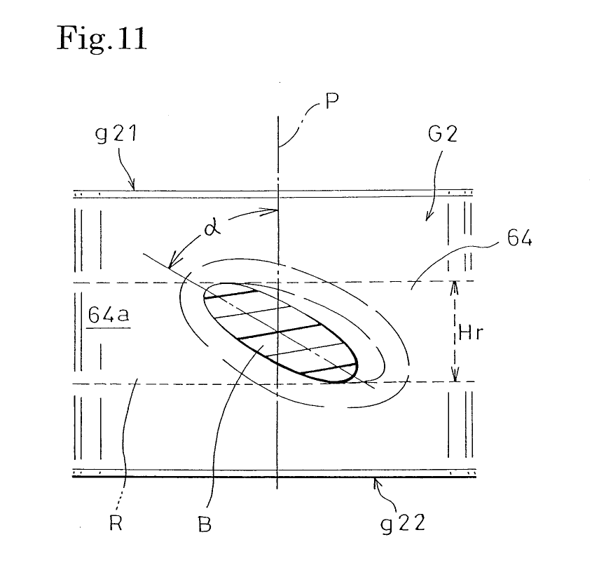

Hereinafter, embodiments of the fluid gasket of the invention will be described with reference to the accompanying drawings by way of an example in which the invention is applied to a connecting structure for an integration panel and a fluid device. FIGS. 1 and 2 are overall and section views of main portions showing the connecting structure for an integration panel and a fluid device, FIG. 3 is a section view of main portions showing in detail a fitting structure between a first ring-like gasket portion and a first fluid supply/discharge port portion, FIGS. 4 to 6A are views showing a fluid gasket of Embodiment 1, FIGS. 6B and 6C are section views showing other section shapes of a bridge portion, FIG. 7 is an overall view showing another connecting structure for an integration panel and a fluid device, FIGS. 8 and 9 are half-section and assembly views of holding means of another structure, and FIGS. 10 and 11 are a plan view of a fluid gasket of Embodiment 2, and a section view of a bridge portion, respectively.

### Embodiment 1

FIGS. 1 and 2 show a connecting structure for an integration panel and a valve. The connecting structure for an integration panel and a valve is a concentric double flow path structure that extends over both an integration panel (an example of the first fluid device) 1 in which plural pipe-like fluid passage 3, 4 are formed, and a valve (an example of the second fluid device) 2 which is mounted on the upper face 1a of the panel via a fluid gasket G having two or inner and outer ring-like gasket portions G1, G2, and that shares the vertical axis P. As the valve 2, various valves such as an on-off valve and a stop valve can be used.

In the integration panel 1, as shown in FIGS. 1 and 2, the pipe-like supply-side fluid passage 3 consisting of: a vertical passage 3a which is vertically formed, and which is opened in the panel upper face 1a; and a lateral passage 3b which laterally extends, and the discharge-side fluid passage 4 consisting of: an annular vertical ring passage 4a which is formed on an outer diameter-side of the vertical passage 3a, and which is opened in the panel upper face 1a; and a lateral passage 4b which communicates with a bottom portion of the ring passage, and which laterally extends are formed in a panel member (or a block member) 5 made of a fluororesin such as PFA or PTFE. The portion where the supply/discharge fluid passages 3, 4 in the integration panel 1 are opened in a double-pipe like manner is referred to as a first fluid supply/discharge port portion 1A. In the first fluid supply/discharge port portion 1A, the pipe-like vertical passage 3a and the annular vertical ring passage 4a are formed as concentric passages having the common axis P. In the first fluid supply/discharge port portion 1A, a lower first seal end portion t21 and lower second seal end portion t22 which have inner and outer annular projections 21, 41 that are annular and centered at the axis P, and that are upward projected are formed in the outer diameter-side portions of the fluid passages 3, 4 which are opened in the upper end face of the port portion, respectively.

As shown in FIGS. 1 and 2, the valve (an example, of the second fluid device) 2 has a valve case 6 which is made of a fluororesin such as PFA or PTFE, and which is circular in a vertical view. A lower end portion of the valve case 6 is formed as a second fluid supply/discharge port portion 2A having: a pipe-like supply-side fluid passage 7 which is vertically placed at the center of the lower end portion in a state where it is opened in the lower face 6a; and an annular discharge-side fluid passage 8 which is formed on the outer-diameter side of the supply-side fluid passage 7, and which is vertically placed in a state where it is opened in the lower face 6a. In the second fluid supply/discharge port portion 2A, namely, the pipe-like supply-side fluid passage 7 and the annular discharge-side fluid passage 8 are formed as concentric passages having the common axis P. A mounting flange 9 which has a pair of bolt insertion holes 9a, and which is made of a fluororesin such as PFA or PTFE or another material is integrated by fusion bonding to an outer peripheral portion of the lower end of the valve case 6. Alternatively, the valve case 6 and the mounting flange 9 are formed as an integral member which is integrally formed by a cutting or molding process. In the second fluid supply/discharge port portion 2A, an upper first seal end portion t11 and upper second seal end portion t12 which have inner and outer annular projections 11, 31 that are annular and centered at the axis P, and that are downward projected are formed in the outer diameter-side portions of the fluid passages 7, 8 which are opened in the lower end face of the port portion, respectively.

As shown in FIGS. 1 to 5, the fluid gasket G is configured by: the inner and outer ring-like gasket portions G1, G2 (hereinafter, abbreviated as the first gasket portion G1, and the second gasket portions G2); and four bridge portions B which integrally connect the gasket portions with each other. The first and second gasket portions G1, G2 are different only in diameter, and have the same section shape. Their structures will be described while taking the inner first gasket portion G1 as an example. In the second gasket portions G2 the description of which is omitted, portions corresponding to those of the first gasket portion G1 are denoted by corresponding reference numerals (for example, 54a→64a). The first gasket portion G1 is configured as a portion made of a fluororesin such as PFA or PTFE, and having: a pipe-like fluid path w1 which is formed so as to allow the vertical passage 3a and supply-side fluid passage 7 that are corresponding passages of the first and second fluid supply/discharge port portions 1A, 2A, to communicate with each other; and a pair of upper and lower annular grooves 51, 51 which are formed on an outer diameter-side portion of the fluid path w1 so as to be fitted with the annular projections 11, 31 of the upper first seal end portion t11 and upper second seal end portion t12 that are formed in the end faces of the first and second fluid supply/discharge port portions 1A, 2A.

Namely, the section shape of the first gasket portion G1 is formed into a substantially H-like shape which has the pair of upper and lower annular grooves 51, 51, and inner and outer peripheral walls 54, 55 for forming the annular grooves 51, 51, in which the upper and lower annular grooves 51, 51 have the same depth and width, and are vertically symmetric, and the inner and outer peripheral walls 54, 55 are laterally symmetric, and which is axisymmetric (or approximately axisymmetric) about both the vertical center line Z along the axis P of the first and second fluid supply/discharge port portions 1A, 2A, and the lateral center line X perpendicular to the vertical center line Z. Upper and lower end portions of the inner peripheral wall 54 are formed as tapered inner peripheral faces 52a, 52a in which upper and lower end portions of the fluid path w1 serving as the inner peripheral face 54a are outward inclined in a funnel-like manner. Also upper and lower end portions of the outer peripheral wall 55 are formed as tapered outer peripheral faces 53a, 53a in which upper and lower end portions of the outer peripheral face 55a are inward inclined.

On the inner- and outer-diameter sides of the annular projections 21, 41 of the lower first and lower second seal end portions t21, t22 of the first fluid supply/discharge port portion 1A of the integration panel 1, and the annular projections 11, 31 of the upper first and upper second seal end portions t11, t12 of the second fluid supply/discharge port portion 2A of the valve 2, annular press projections (an example of the support portions) 12, 13, 22, 23, 32, 33, 42, 43 are formed to prevent inner and outer peripheral wall end portions 52, 53, 62, 63 which are projected in the direction of the axis P in order to form the annular grooves 51, 61 in the gasket portions G1, G2, from being expandingly deformed by fittings between the corresponding annular grooves 51, 61 and the corresponding annular projections 11, 21, 31, 41.

The structure relating to the annular press projections will be described about the first gasket portion G1 and the upper first seal end portion t11. The inner and outer annular press projections 12, 13 are symmetric, and formed as annular projections which have a forward-narrowed shape, and which have a tapered outer peripheral face 12a and a tapered inner peripheral face 13a where side peripheral faces on the side of the annular projections are inclined so that valley portions 14, 15 surrounded by the projections and the annular projection 11 have an inward-narrowed shape (upward narrowed shape). Namely, the upper first seal end portion t11 is a generic term of the annular projection 11, and the annular press projections 12, 13 and valley portions 14, 15 which are formed on the both of inner and outer sides of the annular projection.

Upper end portions of the inner and outer peripheral walls 54, 55 of the first gasket portion G1 have the peripheral wall end portions 52, 53 which are forward-narrowed annular seal projections that have tapered inner and tapered outer peripheral faces 52a, 53a abutting against the tapered outer and tapered inner peripheral faces 12a, 13a of the annular press projections 12, 13, respectively, and that are fittable into the valley portions 14, 15, and are configured in the following manner. In a joined state (see FIG. 1), the peripheral wall end portions 52, 53 which are the end portions of the inner and outer peripheral walls 54, 55 enter the corresponding valley portions 14, 15, the tapered outer peripheral face 12a of the upper first seal end portion t11 is pressingly contacted with the tapered inner peripheral face 52a of the first gasket portion G1, and the tapered inner peripheral face 13a of the upper first seal end portion t11 is pressingly contacted with the tapered outer peripheral face 53a of the first gasket portion G1.

Namely, an upper sealing portion (an example of the second sealing portion) g11 is formed by the annular groove 51 and the peripheral wall end portions 52, 53 inside and outside thereof, in the upper end portion of the first gasket portion G1, and similarly a lower sealing portion (an example of the first sealing portion) g12 is formed in the lower end portion. The upper sealing portion g11 is fitted to the upper first seal end portion t11 to form a fitting sealing portion 10, and the lower sealing portion g12 is fitted to the lower first seal end portion t21 to form a fitting sealing portion 10. Also in the second gasket portion, similarly, an upper sealing portion (an example of the second sealing portion) g21 and a lower sealing portion (an example of the first sealing portion) g22 are formed, and fitted to the upper second seal end portion t12 and the lower second seal end portion t22 to form fitting sealing portions 10, respectively.

The fitting structure of the fitting sealing portions 10 will be described in detail about the upper first seal end portion t11 and the upper sealing portion g11 of the first gasket portion G1. As shown in FIGS. 2 and 3, the inner and outer valley portions 14, 15 are symmetric, and the inner and outer peripheral wall end portions 52, 53 are symmetric. The contained angle ax of the whole of the inner and outer valley portions 14, 15, and the opposed angle β° of the whole of the inner and outer peripheral wall end portions 52, 53 are set to have the relationship of α°<β°. Preferably, the angles are set to have the relationship of α°+(20 to 40°)=β°. According to the configuration, in the joined state (described later) in which the upper annular projection 11 of the upper first seal end portion t11 is fitted to the annular groove 51, the tapered outer peripheral face 12a of the upper inner annular press projection 12, and the tapered inner peripheral face 52a of the upper inner peripheral wall end portions 52 are in a state where they are pressingly contacted with each other in the innermost diameter portion (see the phantom line in FIG. 3), thereby attaining an advantage that they function as a secondary sealing portion S2 which prevents the fluid passing through the fluid path w1 from entering between the tapered outer and tapered inner peripheral faces 12a, 52a.

Between the width d1 of the upper annular projection 11 and the width d2 of the upper annular groove 51, a relationship of d1>d2 is established. Preferably, the widths are set to have the relationship of d1×(0.75 to 0.85)=d2. Between the projection length h1 of the upper annular projection 11 and the depth h2 of the upper annular groove 51, a relationship of h1<h2 is established. According to the configuration, the upper annular projection 11 and the upper annular groove 51, more specifically, the both inner and outer side peripheral faces of the upper annular projection 11, and the corresponding inner and outer side peripheral faces of the upper annular groove 51 are strongly pressingly contacted with each other to form a primary sealing portion S1 which exhibits an excellent sealing performance of preventing the fluid from leaking. Moreover, the tapered outer peripheral face 12a of the upper inner annular press projection 12 surely abuts against the tapered inner peripheral face 52a of the upper inner peripheral wall end portions 52. Accordingly, there is an advantage that the above-mentioned secondary sealing portion S2 is satisfactorily formed.

The tip ends of the annular press projections 12, 13 and the peripheral wall end portions 52, 53 are formed into a shape which is cut so as not to form a pin angle, i.e., into inclined cut faces 12b, 13b and cut faces 52b, 53b. According to the configuration, even when the tip end of the upper inner annular press projection 12 is slightly expandingly deformed toward the fluid path w1, only a recess having a triangular section shape which is largely opened is formed in the middle of the fluid path w1 because they have originally such a cut shape. The fluid existing in the recess easily flows out, and liquid stagnation is substantially prevented from being produced. Moreover, the opening angle of the recess, i.e., the contained angle between the inclined cut face 12b and the tapered inner peripheral face 52a is sufficiently large, and hence the possibility that liquid stagnation due to surface tension is caused is eliminated. The internal and external angles of the tip end of the annular projection 11 are formed as a chamfered shape 11a. Therefore, the press movement into the narrow annular groove 51 can be smoothly performed without causing any problem such as scuffing.

The fitting sealing portion 10 will be described in further detail. As shown in FIGS. 2 and 3, the opening angle (the opening angle between the valley portions 14, 15) D of the tapered peripheral faces 12a, 13a on the side of the annular projection in the annular press projections 12, 13 is set to a value in the range of 50 to 70 deg. (50°≦D°≦70°), and the apical angle E of the tapered peripheral faces 52a, 53a of the peripheral wall end portions 52, 53 is set to a value in the range of 60 to 80 deg. (60°≦E°≦80°). The opening angle D and the apical angle E are set so that the apical angle E is a sum of the opening angle D and an angle of 10 to 20 deg. [D°+(10 to 20°)=E°]. More preferably, the opening angle D is set to 69 to 71 deg. (D°=70±1°), the apical angle E is set to 79 to 81 deg. (E°=80±1°), and the apical angle E to 79 is set to the opening angle D+9 to 11 deg. (E°−D°=10±1°).

The cut angles Ds of the inclined cut faces 12b, 13b of the annular press projections 12, 13 are set to 49 to 51 deg. (Ds°=50°±1°), and the attack angle Es of the tip-end cut faces 52b, 53b of the peripheral wall end portions 52, 53 are set to 124 to 126 deg. (Es°=125°±1°). According to the setting of the angles, the tapered outer peripheral face 12a and the tapered inner peripheral face 52a, and the tapered inner peripheral face 13a and the tapered outer peripheral face 53a abut against each other in an annular line-contact state, the seal-lip effect is exerted in the secondary sealing portion S2.

Namely, the apical angle E of the tapered peripheral faces 52a, 53a (the tapered inner peripheral face 52a, the tapered outer peripheral face 53a) of the peripheral wall end portions 52, 53 with respect to the attracting direction along which the first fluid supply/discharge port portion 1A and the second fluid supply/discharge port portion 2A are attracted to each other is set to a value which is a sum of the opening angle D of the tapered peripheral faces 12a, 13a (the tapered outer peripheral face 12a, the tapered inner peripheral face 13a) on the side of the annular projection 11 in the annular press projections 12, 13, and an angle of 10 to 20 deg., preferably, 10 deg. or about 10 deg. The apical angle E is set to 60 to 80 deg., preferably, 80 deg. or about 80 deg.

In the configuration where the apical angle E and the opening angle D are set to values in the vicinity of 90 deg. and similar to an obtuse angle, the projection amounts of the annular press projections 12, 13 in the attracting direction (axial direction) are smaller than the radial width, and the strengths and rigidities of the projections are relatively improved. Accordingly, there is an advantage that, while restricting the expansions of the peripheral wall end portions 52, 53, the possibility that the annular press projections 12, 13 themselves are radially expandingly deformed can be effectively suppressed. The component force by which the tapered peripheral faces 52a, 53a radially press the annular press projections 12, 13 in an expanding manner can be reduced by the bitings of the peripheral wall end portions 52, 53 into valley portions 14, 15. Also by this phenomenon, the radially expanding deformations of the annular press projections 12, 13 can be suppressed.

The above-described structure of the fitting sealing portion 10 is similarly applied to the lower side of the first gasket portion G1, and also to the second gasket portions G2, and corresponding portions are denoted by corresponding reference numerals. In the second gasket portions G2, the radial dimensions are different, but the section shape is strictly identical with that of the first gasket portion G1. However, the shapes of the upper and lower second seal end portions t12, t22 of the first and second fluid supply/discharge port portions 1A, 2A are slightly different from those of the upper and lower first seal end portions t11, t21 because no fluid passage exists on the outer peripheral side.

In the upper second seal end portion t12, namely, a lower-end inner peripheral portion 6b for forming a lower end portion of the valve case 6 exists in a state where it is continuous to a tapered inner peripheral face 33a of the annular press projection 33. The lower-end inner peripheral portion 6b serves as a guide in the case where the upper sealing portion g21 of the second gasket portions G2 is fitted to the upper second seal end portion t12, and can perform a function of cooperating with the tapered inner peripheral face 33a to prevent an outer peripheral wall 65 of the second gasket portions G2 from being expandingly deformed. In the lower second seal end portion t22, the panel member 5 continuously exists on the outer periphery side of the outer annular press projection 43. The effect that, when the lower sealing portion g22 is fitted to the lower second seal end portion t22, the expanding deformation of the outer peripheral wall end portion 63 of the lower sealing portion g22 of the second gasket portions G2 is blocked by the tapered inner peripheral face 43a is enhanced.

By contrast, in the first and second gasket portions G1, G2, the first gasket portion G1 which is an intermediate gasket in which the fluid passages 7, 8 exist on both the inner and outer diameter sides in the joined state is formed in a state where the outer peripheral face 55a which is an outer peripheral portion of the first gasket portion is a wall for forming an annular fluid path w2 through which the annular fluid passage 4a of the first fluid supply/discharge port portion 1A existing on the outer-diameter side of the first gasket portion G1 communicates with the annular fluid passage 8 of the second fluid supply/discharge port portion 2A. When it is configured so that both the inner and outer peripheral face 54a, 55a of the first gasket portion G1 function also as the walls for forming the fluid paths w1, w2, a relationship of “thickness of first gasket portion G1”=“distance between annular fluid passages 4a, 8 and pipe-like fluid passages 3a, 7” is attained, and it is possible to further compactify the connecting portion between the first and second fluid supply/discharge port portions 1A, 2A.

As indicated by the phantom lines in FIG. 1, a ring-like flange 1f for attachment and detachment which is laterally projected may be integrally formed on the outer peripheral wall 65 of the second gasket portions G2. In this configuration, there is an advantage that, when the second gasket portions G2 is to be pulled out from the first or second fluid supply/discharge port portion 1A, 2A, the pulling operation can be easily performed by, for example, pulling the flange 1f by a tool or the fingers. In this case, the thickness of the attachable and detachable flange 1f is smaller than the distance between the first and second fluid supply/discharge port portions 1A, 2A in the joined state.

As shown in FIGS. 1, 2, and 4 to 6A, the bridge portions B hang between the first and second gasket portions G1, G2 by the shortest distance along a radial direction with respect to the axis P of the fluid paths w1, w2, and are formed in four places in total (two or three places, or five or more places may be employed) at regular angular intervals of 90 deg. centered at the axis P. According to the configuration, the fluid gasket G shows a shape similar to a wheel as seen from the direction of the axis P (an automotive wheel on which a tire is to be mounted) in which the bridge portions B correspond to spokes. As shown in FIG. 6A, the bridge portions B are set to have a circular section shape, and root parts where the portions are connected to the gasket portions G1, G2 are formed in a bottom-spreading shape. Alternatively, the bridge portions B may have an oval section shape which extends vertically (in the direction of the axis P) as shown in FIG. 6B, or a rhombic section shape which extends vertically (in the direction of the axis P) as shown in FIG. 6C. In summary, the section shape is preferably set to a shape in which the dimension Hb along the axis P of the fluid paths w1, w2 is larger than the dimension Sb along a radial direction, from the viewpoint that the bridge portions hardly constitute a resistance to the fluid flow.

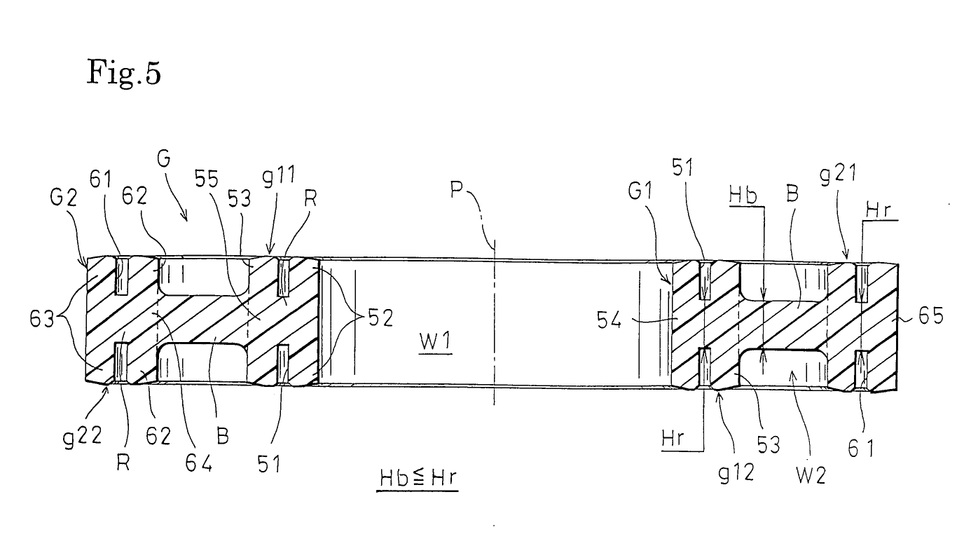

The thicknesses Hb of the bridge portions B along the axis P of the fluid paths w1, w2 are set to have the same value (an example of “value which is equal to or less than”) as the thicknesses Hr of connecting portions R interposed between the first annular grooves 51, 61 and second annular grooves 51, 61 of the first and second gasket portions G1, G2, along the axis P. As shown in FIG. 5, the bridge portions B are formed at positions which correspond to the connecting portions R in the direction of the axis P.

The bridge portions B have a circular section shape so as to hardly constitute a resistance to the fluid flowing through the discharge-side fluid passage 8 (the second fluid path w2), and so as not to impede the radial displacements of the peripheral wall end portions 52, 53, 62, 63 which are based on the connecting portions R in the gasket portions G1, G2. Therefore, the excellent sealing property is maintained irrespective of the existence of the bridge portions. This is because of the following reason. If the thicknesses Hb of the bridge portions B are larger than the thicknesses Hr of the connecting portions, a state similar to that where the outer peripheral wall end portion 53 of the first gasket portion G1 is rigidly connected to the inner peripheral wall end portion 62 of the second gasket portions G2 is produced, and only the vicinities of the bridge portions B are hardly moved in a radial direction, thereby causing the possibility that the sealing property is adversely affected. Although not illustrated, the thicknesses Hb of the bridge portions B may be smaller than the thicknesses Hr of the connecting portions R. Namely, it is requested that Hb≦Hr.

Next, holding means I will be described. As shown in FIGS. 2 and 3, the holding means I is configured so that the first fluid supply/discharge port portion 1A of the integration panel 1 and the second fluid supply/discharge port portion 2A of the valve 2 are attracted to each other via the first and second gasket portions G1, G2, and the attracting function holds the joined state where the upper first and upper second seal end portions t11, t12 of the second fluid supply/discharge port portion 2A and the upper sealing portions g11, g21 of the first and second gasket portions G1, G2, the lower first and lower second seal end portions t21, t22 of the first fluid supply/discharge port portion 1A, and the lower sealing portions g12, g22 of the first and second gasket portions G1, G2 are fitted to each other to form the fitting sealing portions 10. Namely, the annular projections 11, 31 of the second fluid supply/discharge port portion 2A are fitted into the upper annular grooves 51, 61 of the first and second gasket portions G1, G2, and the annular projections 21, 41 of the first fluid supply/discharge port portion 1A are fitted into the lower annular grooves 51, 61 of the first and second gasket portions G1, G2.

The structure of the holding means I is configured by: a pair of bolts 66 which are passed through bolt passage holes 9a of the mounting flange 9 of the second fluid supply/discharge port portion 2A; and nut portions 67, 67 which are formed correspondingly with the pair of bolt passage holes 9a, 9a in the first fluid supply/discharge port portion 1A (the panel member 5). By a fastening operation of fastening the bolts 66 to the nut portions 67, the valve 2 can be attracted to the integration panel 1, and the attracted state can be held. In the case where the press contact forces of the fitting sealing portions 10 are reduced because of aging, occurrence of creep, or the like, the reduction can be coped with by further fastening the bolts 66, and therefore the excellent sealing property can be held.

### Embodiment 2

The fluid gasket G of Embodiment 2 is different in the bridge portions B from that of Embodiment 1. As shown in FIG. 10, the bridge portions B of the fluid gasket G of Embodiment 2 are formed in five places (places the number of which is other than five, such as six places may be employed) at regular angular intervals about the axis P. The bridge portions configure a spiral pattern as seen from the direction of the axis P so that swirl motion can be caused in the fluid flow in the fluid paths w1, w2. When a fluid such as water flows in the pipe while swirling, namely, the bridge portions B are formed into a shape which extends along the flow, and the resistance to the flow can be reduced.

Furthermore, the bridge portions B are formed into a screw-like shape which can change the flow direction of the fluid in the fluid paths w1, w2. Specifically, as shown in FIG. 11, means for forming the section shapes of the bridge portions B into an oval shape, and causing the axis Q of the major axis side to be inclined by an angle of a with respect to the axis P is employed. According to the configuration, a situation where the five bridge portions B constitute a screw (propeller) is produced to create a function of, when the fluid passes the bridge portions, changing or twisting the flow direction of the fluid. When the pipe in the downstream side is largely bent, or the inner wall of the pipe is corrugated, for example, an action of stirring the fluid is caused in the bent portion or the recess portion, thereby eliminating the phenomenon that the fluid stagnates in the portion. Therefore, an effect that a satisfactory flow state is obtained can be expected.

Next, several other examples of the fluid device connecting structure to which the fluid gasket G of Embodiment 1 is applied will be described.

[Other Embodiment 1 of Connecting Structure]

As shown in FIG. 7, a fluid device connecting structure of other embodiment 1 is used for communicatingly connecting the integration panel 1 to a pump 2 (such as a bellows pump for a circulation line of a cleaning apparatus) via a flanged pipe 71. The fluid gasket G is interposed between the integration panel 1 and the flanged pipe 71. The configuration of the connecting portion itself in which the inner and outer or first and second gasket portions G1, G2 are interposed is identical with that of the connecting portion described in Embodiment 1. Therefore, only principal components are denoted by the reference numeral, and the detailed description of the configuration is omitted.

The integration panel 1 is basically identical in structure as the integration panel 1 shown in FIG. 1 except that the direction of the discharge-side fluid passage 4 is opposite to that in the case of the integration panel 1 shown in FIG. 1. In the configuration of FIG. 1 where the connecting structure between the integration panel and the fluid device is configured on the upper face of the integration panel. However, the connecting structure of the other embodiment is configured on a side face of the integration panel 1. The supply/discharge fluid passages 7, 8 of the pump 2 are opened in the side face. In the integration panel 1 of FIG. 1, the pair of fluid passages 3, 4 have the double-pipe structure. By contrast, in the other embodiment, the fluid passages are of the independent type in which they are vertically arranged.

The flanged pipe 71 consists of: a flange portion 72 having the above-described mounting flange 9; and a substantially bifurcated pipe portion 73 which is continuous to the flange portion. The pipe portion 73 is configured by a supply-side pipe 73A having a pipe-like supply-side fluid passage 74, and a discharge-side fluid passage 73B having a pipe-like discharge-side fluid passage 75. In the flange portion 72, the supply-side fluid passage 74 is formed into a pipe-like shape centered at the axis P, and opened while being directly opposed to the vertical passage 3a of the integration panel 1, and an annular passage portion 75a which is directly opposed to the vertical ring passage 4a of the integration panel 1 is formed in a state where it is continuous to the discharge-side fluid passage 75. The fluid passages 74, 75 are communicatingly connected and coupled to an in-side port 76 and an out-side port 77 of the pump 2 by means such as fusion bonding.

As described above, the flanged pipe 71 having the flange portion 72 of the double-pipe structure, and pipe portion 73 having the two independent pipes is used. Therefore, the first fluid supply/discharge port portion 1A of the double-pipe structure in the integration panel 1, and the second fluid supply/discharge port portion 2A configured by the pair of in-side and out-side ports 76, 77 which are arranged in parallel, i.e., the integration panel 1 and the pump 2 can be communicatingly connected to each other in juxtaposed, unforced, and compact manners, although the fluid passages have the different opening structures. The structure relating to the fluid gasket G is identical with that shown in FIG. 1.

[Other Embodiment 2 of Connecting Structure]

FIGS. 8 and 9 show a connecting structure for fluid devices of other embodiment 2. The connecting structure is different only in the holding means I from that shown in FIG. 1. The holding means I of a first other structure will be described. In FIGS. 8 and 9, portions corresponding to those of the connecting structure shown in FIGS. 1 to 3 are denoted by corresponding reference numerals. As shown in FIGS. 8 and 9, the holding means I of the first other structure is configured by: a cylindrical nut 81 having an internal thread 81n which is screwable with an external thread in formed on an outer peripheral portion of the projection-like first fluid supply/discharge port portion 1A that is formed on the upper face of the integration panel 1, and that is circular in a plan view; and a split ring 82 which has two or three or more pieces, and which interferes in the direction of the axis P of the annular fluid passage 7 with the outward flange 9 that is formed in a lower end portion of the valve case 6 of the valve 2. The holding means I is configured as holding means having the attracting function in which, by a fastening operation of the cylindrical nut 81 in which the internal thread 81n is screwed with the external thread 1n of the first fluid supply/discharge port portion 1A, the fluid supply/discharge port portions 1A, 2A can be attracted in the direction along which they approach each other via the fluid gasket G, and the attracted state can be held.

An opening portion 83a of an inward flange 83 which is formed on the cylindrical nut 81 on the side of the valve 2 (the upper side) is set to have a minimum internal diameter which is sufficient for allowing the passage of the outward flange 9. The outer diameter of the split ring 82 is set to be slightly smaller than the inner diameter of the internal thread 81n so that the split ring can freely enter the cylindrical nut 81, and the inner diameter is set to a minimum dimension by which the split ring is fittable onto the outer diameter portion of the circular second fluid supply/discharge port portion 2A of the valve 2. In this case, in order to mount the split ring 82, the axial length of a small-diameter portion of the second fluid supply/discharge port portion 2A excluding the outward flange 9 must be larger than the sum of the axial length of the cylindrical nut 81 and the thickness of the split ring 82. Specifically, the conditions that, as shown in FIG. 9B, the distance d3 between the cylindrical nut 81 in a state where it abuts against a root portion 6t of valve case 6, and the outward flange 9 is larger than the thickness d4 of the split ring 82 (d3>d4) is imposed.

Between an inner end portion of the internal thread 81n of the cylindrical nut 81 and the inward flange 83, an inner peripheral face portion 81m which is axially slidable on the split ring 82, and which has a length in the direction of the axis P that covers the width dimension of the split ring 82 is formed into a flat inner peripheral face which is coaxial with the axis P. Namely, the inner peripheral face portion 81m between the internal thread 81n of the cylindrical nut 81 and the inward flange 83 is formed into a flat inner peripheral face which is coaxial with the supply-side fluid passage 7, and the dimensions are set to a fitting tolerance state where the inner peripheral face portion 81m is very slightly larger than the outer diameter of the split ring 82 which is formed so as to have a rectangular section shape. By contrast, an outer diameter portion of the second fluid supply/discharge port portion 2A is formed into a flat outer peripheral face which is coaxial with the supply-side fluid passage 7, and has a diameter which is substantially equal to the inner diameter of the split ring 82. According to the configuration, it is possible to eliminate disadvantages that, when the cylindrical nut 81 is screwingly advanced, the split ring 82 is inclined to gouge, and that the pressing force in the direction of the axis P due to the screw advancement of the cylindrical nut 81 is not well transmitted to the outward flange 9. Therefore, the outward flange 9 can be effectively pressed, and the first and second fluid supply/discharge port portions 1A, 2A can be satisfactorily attracted in the direction along which they approach each other.

The fluid supply/discharge port portions 1A, 2A are connected and coupled to each other by the holding means I of the first other structure in the following operation procedure. First, as shown in FIG. 9A, the cylindrical nut 81 is passed over the outward flange 9 to be fitted onto the outer periphery of the second fluid supply/discharge port portion 2A of the valve 2, and is moved to the innermost portion (until it abuts against the root portion 6t). Then, as shown in FIG. 9B, the split ring 82 is passed between the outward flange 9 and the tip end of the cylindrical nut 81, to be fitted onto the second fluid supply/discharge port portion 2A. At or prior to this, the fluid gasket G may be attached to the end face of one of the fluid supply/discharge port portions 1A, 2A via provisional fittings between the annular projections 11, 21, 31, 41 and the annular grooves 51, 61. Next, the first fluid supply/discharge port portion 1A is placed on the second fluid supply/discharge port portion 2A via the fluid gasket G, the cylindrical nut 81 is slid under this state, and a fastening operation [see FIG. 9C] is then conducted, whereby the connection state shown in FIG. 8 is obtained. In FIG. 9, for the sake of convenience in drawing, the integration panel 1 and valve 2 which are vertically stacked to each other are shown in a laterally arranged manner.

### Other Embodiments

In the fluid gasket G, although not illustrated, the second gasket portions G2 on the outer-diameter side may have a structure in which the vertical dimension of the outer peripheral wall 65 is shorter than that of the inner peripheral wall 64, and which is formed simply by horizontally cutting the upper and lower ends. In the double-pipe connecting structure, the outer peripheral wall 65 of the second gasket portions G2 on the outermost diameter side may not be provided with the sealing function. In the embodiments, the first and second gasket portions G1, G2 are vertically and laterally symmetric. Alternatively, for example, the gasket portions may be configured so that the inter and outer peripheral walls have different lengths or thicknesses, or they are vertically asymmetric, and are not restricted to the illustrated shapes. A triple or more connecting structure for three or more fluid devices which has one or plural annular fluid passages in the outside of the outer annular fluid passage 8 may be possible. A configuration in which, in gasket portions other than the gasket portion existing in the outermost side, their inner and outer peripheral faces function also as fluid passages may be employed.

The bridge portions B may have various configurations such as those in which a single wide bridge portion is used, or in which two or more bridge portions are formed in the circumferential direction about the axis P. The section shape may be changed to various shapes (for example, a triangular section shape, a rectangular section shape, a Clark-Y type section shape, and a laminar wing section shape) other than those of FIG. 6. The term “fluid device” in the invention is defined as a generic term of devices relating to fluid, such as a valve, a pump, an accumulator, a fluid storage vessel, a heat exchanger, a regulator, a pressure gage, a flowmeter, a heater, a flanged pipe, and an integration panel.

What is claimed is:

1. A fluid gasket having:
plural ring-like gasket portions which, in order to communicatingly connect a first fluid supply/discharge port portion of a first fluid device having said first fluid supply/discharge port portion where a pipe-like or annular fluid passage, and one or more annular fluid passages are concentrically formed and opened, to a second fluid supply/discharge port portion of a second fluid device having said second fluid supply/discharge port portion where a pipe-like or annular fluid passage, and one or more annular fluid passages are concentrically formed and opened, in a state where respective ones of said plural fluid passages correspond to each other and are sealed, are to be interposed between said first fluid supply/discharge port portion and said second fluid supply/discharge port portion, and in which first sealing portions that are to abut against said first fluid supply/discharge port to perform a sealing operation, second sealing portions that are to abut against said second fluid supply/discharge port to perform a sealing operation, and a fluid path for communicating said fluid passages of said first fluid supply/discharge port portion with said fluid passages of said second fluid supply/discharge port portion are formed; and
a bridge portion which is placed in a state where said bridge portion traverses said fluid path in order to couple and integrate ones of said plural ring-like gasket portions with each other, said ones being adjacent to each other in a radial direction.

2. A fluid gasket according to claim 1, wherein said bridge portion is set to have a section in which a dimension of said fluid path along an axial direction is larger than a dimension along a radial direction with respect to the axis.

3. A fluid gasket according to claim 1, wherein said bridge portion is formed into a screw-like shape which can change a flow direction of a fluid in said fluid path.

4. A fluid gasket according to claim 1, wherein said bridge portion is formed into a spiral shape to enable swirl motion to be applied to a flow of a fluid in said fluid path.

5. A fluid gasket according to claim 1, wherein said plural ring-like gasket portions comprise: said first sealing portion having a first annular groove which is to be fitted to a first annular projection formed on an outer-diameter portion of said fluid passage of said first fluid supply/discharge port portion, thereby allowing said first sealing portion to be formable; and said second sealing portion having a second annular groove which is to be fitted to a second annular projection formed on an outer-diameter portion of said fluid passage of said second fluid supply/discharge port portion, thereby allowing said second sealing portion to be formable, the fittings being performed so that, in a joined state where said first fluid supply/discharge port portion and said second fluid supply/discharge port portion are attracted to each other, said first annular projection is fitted to said first annular groove, and said second annular projection is fitted to said second annular groove, said gasket presents a substantially H-like section shape to freely form fitting sealing portions in which said first annular projection and said first annular groove, and said second annular projection and said second annular groove are pressingly contacted with each other in a radial direction.

6. A fluid gasket according to claim 5, wherein, in said bridge portion, a thickness along a direction of an axis of said flow path is set to a value which is equal to or lees than a thickness of a connecting portion along the direction of the axis of said flow path, said connecting portion being interposed between groove bottoms of said first and second annular grooves in said ring-like gasket portions, and said bridge portion is formed at a position corresponding to said connecting portion in the axial direction of said flow path.

7. A fluid gasket according to claim 5, wherein said fluid gasket has expansion restricting portions formed in end portions of inner and outer peripheral walls which are projected in the axial direction of said fluid path in each of said first and second sealing portions to form said annular grooves, said expansion restricting portions cooperating with support portions which are formed on inner- and outer-diameter portions of said annular projections in end portions of said first and second fluid supply/discharge port portions, to suppress or block expanding deformations of end portions of said inner and outer peripheral walls due to fittings of said annular grooves and said annular projections.

8. A fluid gasket according to claim 7, wherein said expansion restricting portions are configured so as to be pressingly contacted with said support portions in the joined state to form said sealing portions.

9. A fluid gasket according to claim 8, wherein said expansion restricting portions are configured by peripheral wall end portions of said inner and outer peripheral walls which have a forward-narrowed section shape, and which are enterable into valley portions surrounded by said support portions and said annular projections so as to have an inward-narrowed section shape, and, in the joined state, tapered peripheral faces formed on said peripheral wall end portions are pressingly contacted with tapered peripheral faces on a side of said annular projections in said support portions.

10. A fluid gasket according to claim 5, wherein said plural ring-like gasket portions are set so that the substantially H-like section shape is axisymmetric about both a center line along the axis direction of said fluid path, and a center line perpendicular to the center line.

11. A fluid gasket according to claim 1, wherein said fluid gasket is formed by a fluororesin.
